(19) United States
(12) Patent Application Publication
(10) Pub. No.: US 2023/0161845 A1
(43) Pub. Date: May 25, 2023

(54) METHOD OF UPDATING DATA CLUSTER

(71) Applicants: Inventec (Pudong) Technology Corporation, Shanghai (CN); INVENTEC CORPORATION, Taipei (TW)

(72) Inventor: Chun-Yen Kuo, Taipei (TW)

(21) Appl. No.: 17/551,287

(22) Filed: Dec. 15, 2021

(30) Foreign Application Priority Data
Nov. 19, 2021 (CN) 202111374201.4

(51) Int. Cl. G06K 9/62; G06F 16/28

(52) U.S. Cl. CPC G06K 9/6222; G06K 9/6272; G06F 16/285

(57) ABSTRACT

A method of updating data cluster, adapted to a computing device, includes receiving update data, and calculating a first distance between the update data and an existing representative of an existing cluster, determining whether the first distance is smaller than a threshold distance, updating the existing cluster with the update data to generate an updated cluster when the first distance is smaller than the threshold distance, and performing a representative updating procedure on the updated cluster to generate an updated representative.

### CROSS-REFERENCE TO RELATED APPLICATIONS

This non-provisional application claims priority under 35 U.S.C. § 119(a) on Patent Application No(s). 202111374201.4 filed in China on Nov. 19, 2021, the entire contents of which are hereby incorporated by reference.

### BACKGROUND

### 1. Technical Field

This disclosure relates to a method of updating data cluster.

### 2. Related Art

Conventional data clustering may only be used when every piece of data is obtained, wherein the most common data clustering method is the k-means clustering. However, most clustering methods like k-means clustering have one common problem, which is the user does not know how many clusters to divide the data into (that is, no knowing how to choose a proper value “k”). If an inappropriate value k is selected, it may lead to poor clustering results. Another common problem is that, in the ear of big data, data used to perform data clustering may be multi-dimensional data (that is, value “d” may be larger), thereby increasing the complexity of data clustering, while conventional data clustering method is unable to obtain clustering results quickly when facing large value k and value d.

In addition, the reality is that, all pieces of data that needs to be clustered is usually not obtained at once, some pieces of data are obtained first, and other pieces of data are obtained during the process of clustering or analysis. Updating a data cluster usually involves adding new data into the cluster, but the data cluster sometimes may also be updated by modifying data in the data cluster or deleting data from the data cluster. Therefore, if the conventional data clustering method is used, the system may need to perform data clustering on every piece of data again every time the data cluster is updated. As the number of pieces of data increases, the time required to perform data clustering again also increases.

### SUMMARY

Accordingly, this disclosure provides a method of updating data cluster.

According to one or more embodiment of this disclosure, a method of updating data cluster, adapted to a computing device includes: receiving update data, and calculating a first distance between the update data and an existing representative of an existing cluster; determining whether the first distance is smaller than a threshold distance; updating the existing cluster with the update data to generate an updated cluster when the first distance is smaller than the threshold distance; and performing a representative updating procedure on the updated cluster to generate an updated representative.

In view of the above description, according to one or more embodiments of the method of updating data cluster of the present disclosure, the computing device may perform data clustering using a less amount of time as well as less amount of computation. Further, according to one or more embodiments of the method of updating data cluster of the present disclosure, a proper number of clusters may be automatically generated, and the user does not need to manually choose the value k.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a flowchart illustrating a method of updating data cluster according to an embodiment of the present disclosure;

FIG. 2 is a detailed flowchart illustrating step S05 of FIG. 1;

FIG. 3 is a detailed flowchart illustrating step S07 of FIG. 1; and

FIG. 4 is a flowchart illustrating a method of updating data cluster according to another embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and characteristics of the present invention. The following embodiments further illustrate various aspects of the present invention, but are not meant to limit the scope of the present invention.

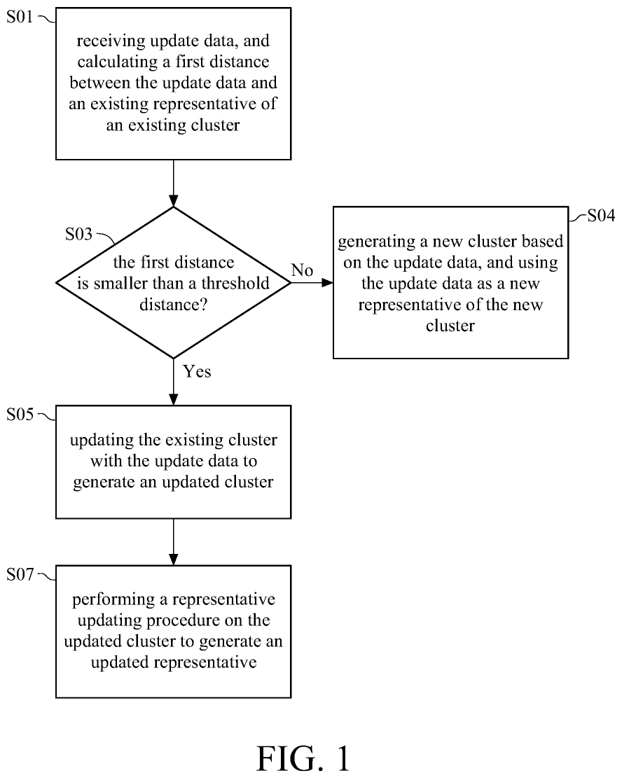

Please refer to FIG. 1. FIG. 1 is a flowchart illustrating a method of updating data cluster according to an embodiment of the present disclosure. The method of updating data cluster of the present disclosure is adapted to a computing device. The computing device may be a central processing unit (CPU), a digital signal processor (DSP), a microprocessor (MPU), a server, etc., the present disclosure does not limit the type of the computing device used to perform the method of updating data cluster. In addition, “cluster” and “data” described in the present disclosure are preferably stored in a memory electrically connected to the computing device or in communication connection with the computing device. The memory may also be a memory installed in the computing device. The computing device may access the cluster and data stored in the memory.

“Cluster” described in the present disclosure indicates a set of one or more pieces of data, wherein the data in the same cluster shares the same or similar characteristics; and “representative” is the data representing the cluster. “Distance” described in the present disclosure indicates a difference between two pieces of data, and the distance is larger when the difference between the two pieces of data is larger; on the contrary, the distance is smaller when the difference between the two pieces of data is smaller.

The speed of the computing device updating a cluster may be up to 20 to 30 times per second. Therefore, the method of updating data cluster of the present disclosure may be applied to license plate recognition. Specifically, in license plate recognition, one representative may be one license plate number, and the cluster of the representative includes data that is the same as the license plate number or data that is similar to the license plate number.

For example, the license plate numbers recognized by a license plate recognition system may include “ABC-1234”, “ABC-123”, “BC-123” etc.; the cluster is a set including “ABC-1234”, “ABC-123”, “BC-123”; and “representative” of the cluster of “ABC-1234”, “ABC-123”, “BC-123” may be “ABC-1234”, wherein a representative is used to represent all pieces of data of a cluster. In addition, a dimension of the cluster data may be larger than 1 and is an integer. For example, in addition to the license plate number, the cluster data may further include characteristics such as vehicle color, vehicle type, vehicle direction, and the cluster data may be a combination of one or more of the characteristics. Therefore, the cluster data may be presented as a vector, such as the vector: (license plate number; vehicle type; vehicle direction). Accordingly, the difference between the clusters may be more obvious, and the clusters may be distinguished more accurately.

For better understanding, the following uses one-dimensional data as an example for description. In step S01 of FIG. 1, the computing device receives update data and calculates a first distance between the update data and an existing representative of an existing cluster. The update data may be data the computing device just received from an external device (for example, the license plate recognition system), and the existing cluster may be a cluster already exits and is accessible to the computing device.

Take license plate recognition as an example, the update data may be a real-time license plate number and is recognized by the license plate number recognition system, and the existing cluster is a set of a plurality of license plate numbers already collected. Assuming the existing cluster includes the license plate numbers described above, and the existing representative is “ABC-1234”, then the computing device calculates the difference between the real-time license plate number and the existing representative “ABC-1234” in step S01. In this example, the update data that is the real-time license plate is “BC-123”, and the existing representative is “ABC-1234”. Since the update data does not contain letter “A” and number “4”, the computing device determines out of five characteristics of the update data, the number of characteristics different from the seven characteristics of the existing representative is two, meaning the first distance is 2/7. The first distance may also be calculated by using string similarity algorithm such as Levenshtein distance.

In addition, as described above, the update data may include a plurality of characteristics. Therefore, before calculating the first distance, the computing device may further determine whether the update data is valid data based on a pre-stored data chart. For example, the pre-stored data chart may record relationships between vehicle types and license plate numbers. For example, the pre-stored data chart may record the license plate number for electric vehicle starts with “EA”. Accordingly, when the vehicle type of the update data is electric vehicle, but the license plate number of the update data does not start with “EA”, the computing device may determine the update data is invalid data and deletes (abandons) the update data. On the other hand, when the vehicle type of the update data is electric vehicle, and the license plate number of the update data starts with “EA”, the computing device may determine the update data is valid data and calculates the first distance based on the update data as well as perform the following steps.

In step S03, the computing device determines whether the first distance is smaller than a threshold distance. Assuming the distance is represented by numerical values from 0 to 1, and take string similarity as an example, the distance is 0 when the license plate numbers are identical; the distance is 1 when the license plate numbers are completely different; and the threshold distance is 0.15. In this step, the computing device determines whether the first distance is smaller than 0.15 to determine which subsequent step to perform.

When the computing device determines the first distance is not smaller than the threshold distance, it means a difference between the update data and the existing representative is relatively large. Therefore, in step S04, the computing device generates a new cluster, and uses the update data as a new representative of the new cluster.

In other words, since the update data and the existing cluster are likely to be different license plate numbers, the computing device may use the update data as the new cluster, and use the update data as the new representative of the new cluster. That is, when the new cluster has just been generated, the new cluster may only include one piece of data, which is the update data, and the new representative of the new cluster is the update data.

Please refer to step S03 again. When the computing device determines the first distance is smaller than the threshold distance, it means the update data and the existing representative are likely to be the same license plate number. Therefore, in step S05, the computing device uses the update data to update the existing cluster to generate an updated cluster.

In step S05, in addition to adding the update data into the existing cluster, the computing device may also delete the update data from the existing cluster, and/or replace existing data in the existing cluster with the update data. The present disclosure does not limit the method updating the existing cluster.

Through steps S03 to S05, the pieces of data in the same cluster may be similar with each other at the same time the difference between different clusters may be enhanced.

Then, in step S07, the computing device performs a representative updating procedure on the updated cluster to generate an updated representative. The existing cluster includes a plurality of pieces of existing data, and based on the updating method used in step S05, the updated cluster may include all pieces of existing data and the update data, include the update data and other pieces of existing data that are not replaced with the update data, or include the pieces of existing data excluding one piece of deleted existing data that is the update data. Specifically, no matter which updating method is used in step S05, the data composition of the existing cluster has changed for the existing cluster to become the updated cluster. Therefore, the computing device may perform the representative updating procedure on the updated cluster to generate the updated representative according to the data of the updated cluster.

In addition, the method of updating data cluster of the present disclosure may also be implemented by determining a similarity between two pieces of data, wherein the larger the similarity is, the more likely that the two pieces of data are indicating the same data. In detail, in step S01, the computing device may calculate a similarity between the update data and the existing representative of the existing cluster. Then in step S03, the computing device determines whether the similarity reaches a threshold value. If the similarity does not reach the threshold value, the computing device may perform step S04; if the similarity reaches the threshold value, the computing device may perform step S05. For example, the update data is “BC-123”, the existing representative is “ABC-1234”, and the threshold value is 9/10. In step S01, the computing device determines the five letters of the update data are the same as five out of the seven letters of the existing representative, the similarity is 5/7. Then in step S03, the computing device determines whether the similarity reaches the threshold value 9/10. In this example, since the similarity (5/7) does not reach the threshold value (9/10), the computing device performs step S04. If, in another example, the computing device determines the similarity reaches the threshold value, the computing device may perform step S05.

According to the method of updating data cluster of the present disclosure, whenever the computing device receives update data, the computing device may compare the update data with the representatives of the existing clusters to determine the cluster that may need to be updated with the update data. Accordingly, the computing device does not need to compare the update data with all pieces of data of all of the clusters, the amount of computation of the computing device may be significantly reduced.

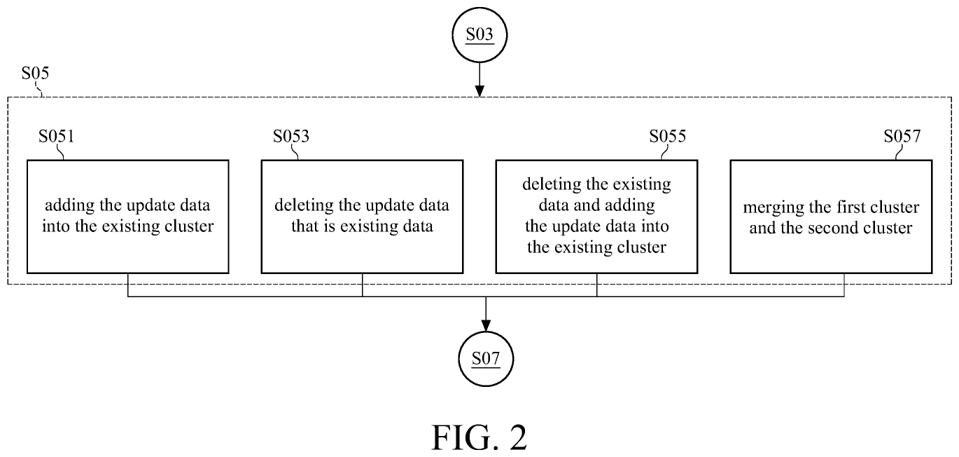

Please refer to FIGS. 1 and 2 together. FIG. 2 is a detailed flowchart illustrating step S05 of FIG. 1, wherein FIG. 2 illustrates the embodiment of updating the existing cluster with the update data.

Take license plate recognition as an example, a camera continuously obtains images of vehicles that pass by the camera, and the license plate recognition system continuously performs recognition on the license plate numbers, wherein each license plate number obtained in real-time is update data. Therefore, after determining the existing representative that the update data is the closest to, in step S051, the computing device may add the update data into the existing cluster of the existing representative to generate the updated cluster.

In addition, the computing device may obtain a data deletion command associated with the update data in step S01, wherein the data deletion command is used to instruct the computing device to delete the update data. In other words, in this example, the update data is the existing data designated to be deleted, and the method of updating the existing cluster is to delete the update data that is the existing data from the existing cluster.

In detail, a number of the existing clusters is usually more than 1. Therefore, after receiving the data deletion command, the computing device compares the existing representatives of the existing clusters with the update data in step S03. After determining the existing representative that is the closest to the update data, in step S053, the computing device may delete the existing representative that is the update data from the existing data.

Take the license plate numbers listed above as an example, assuming the data deletion command indicates deleting the license plate number “BC-123”, then in this case, “BC-123” is the update data. In step S03, based on the distances between the update data and one or more existing representatives, the computing device determines the existing representative corresponding to the update data is “ABC-1234”, the computing device may delete the update data of “BC-123” from the cluster of “ABC-1234”.

In step S01, the computing device may receive a data replacing command associated with the update data and the existing data, wherein the data replacing command is used to instruct the computing device to replace the existing data with the update data. Therefore, after receiving the data replacing command, in step S03, the computing device compares the existing data that is designated to be replaced with a plurality of existing representatives of a plurality of existing clusters. After determining the existing cluster that the existing data belongs to, in step S055, the computing device deletes the existing data from the existing cluster, and adds the update data into the existing cluster.

Or, in step S01, the update data received by the computing device may be a first cluster, the existing cluster may be a second cluster, and the existing representative may be a second representative. After receiving the first cluster, in step S03, the computing device determines whether the first distance between a first representative of the first cluster and the second representative of the second cluster is smaller than the threshold distance. When the first distance is smaller than the threshold distance, it means the first cluster and the second cluster are close (similar) to each other and are likely to indicate the same data. Therefore, the computing device may perform step S057 to merge the first cluster and the second cluster, and use the merged cluster as the updated cluster.

In addition, when the number of the existing clusters is more than 1, with one of the existing clusters is updated by steps S051, S053 or S055 and the updated representative is generated, the updated representative may be compared with the existing representatives of the remaining existing clusters. That is, when one of the existing clusters is updated by steps S051, S053 or S055 and the updated representative is generated in step S07, the computing device may perform step S01 on the updated representative and the existing representatives of the remaining existing clusters. Then, when the computing device determines the existing representative that is the closest to the updated representative, the computing device may merge the cluster of the updated representative with the existing cluster of said closest existing representative (step S057). The computing device may further perform step S07 on the merged cluster to generate a representative for the merged cluster. Through the mechanism of cluster merging, the clusters may be distinguished more accurately.

Accordingly, through step S05 in FIG. 2, when update data in a cluster needs to be deleted, replaced, or update data needs to be added into a cluster, the computing device only needs to compare the update data with the existing representatives of the existing clusters to determine the cluster that needs to be updated with the update data, thereby reducing the amount of computation and computing time the computing device spends on searching the cluster that needs to be updated with the data.

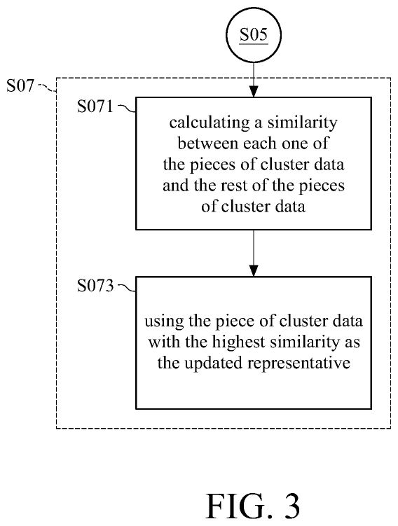

Please refer to FIG. 3. FIG. 3 is a detailed flowchart illustrating step S07 of FIG. 1, wherein FIG. 3 illustrates the embodiment of the representative updating procedure.

When the update data is added into the existing cluster, the update data is deleted from the existing cluster, or the update data is used to replace the existing data in the existing cluster, the existing cluster becomes the updated cluster, and the existing representative may also change accordingly. Therefore, through step S07, the updated cluster may still have an updated representative that is the most representative for the data in the updated cluster after the cluster is updated.

In detail, step S07 may further include steps S071 and S073. In step S071, the computing device calculates a similarity between each one of the pieces of cluster data and the rest of the pieces of cluster data. Then in step S073, the computing device uses the piece of cluster data with the highest similarity as the updated representative.

The updated cluster may include a plurality of pieces of cluster data, and in step S071, the computing device determines the similarities between every two pieces of cluster data of the plurality of pieces of cluster data, wherein the computing device may calculate the similarities through string similarity algorithm. Then, the computing device may perform step S073 to use the piece of cluster data with the highest similarity as the updated representative.

In other words, a similarity exits between each piece of cluster data and each piece of the remaining cluster data, meaning one piece of cluster data corresponds to a plurality of similarities. The computing device may use the cluster data with the highest average similarity as the updated representative of the updated cluster. In addition, the implementation of step S07 may also be using the set of the cluster data as the representative.

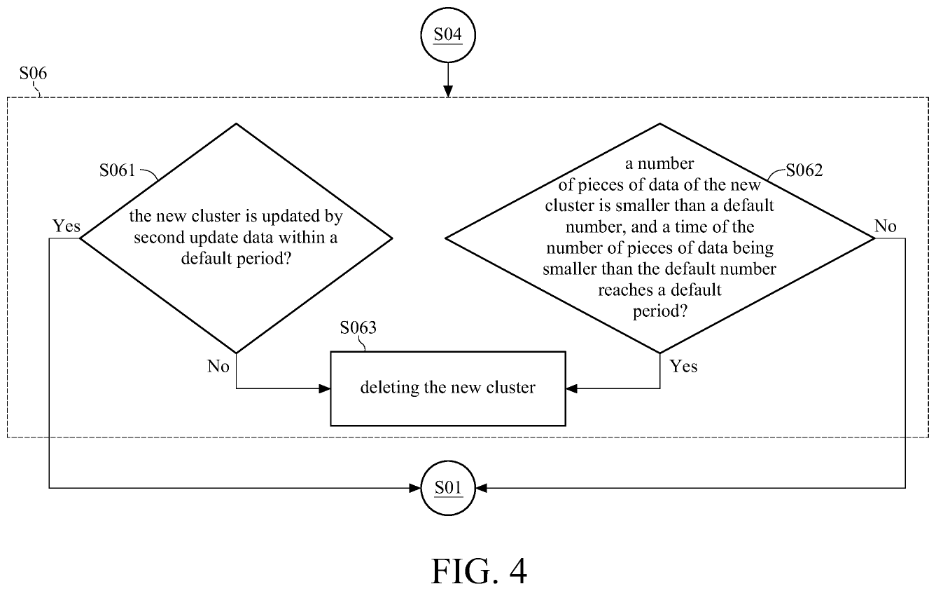

Please refer to FIG. 4. FIG. 4 is a flowchart illustrating a method of updating data cluster according to another embodiment of the present disclosure. Since the embodiment of FIG. 4 is similar to that of FIG. 1, the following focuses on explaining the difference between FIG. 4 and FIG. 1. The embodiment of FIG. 4 further includes step S06, wherein step S06 is performed after step S04. For better understanding, the following refers the update data received in step S01 as first update data, and the update data received after step S01 as second update data.

After generating the new representative, in step S061, the computing device may determine whether the new cluster is updated by the second update data within a default period, wherein the computing device starts timing the default period after the first update data is received or after the new representative is generated. After receiving the first update data, the computing device may continue to receive the second update data, and in step S061, the computing device determines whether the new cluster is updated by the second update data within the default period, wherein a second distance between the second update data and the new representative of the new cluster is smaller than the threshold distance.

Take license plate recognition as an example, when the computing device determines the new cluster is updated within the default period, it means the license plate number corresponding to the new cluster is still within the shooting range of the camera. Therefore, the computing device may continue to perform step S01 to continuously receive update data. On the contrary, when the computing device determines the new cluster is not updated within the default period, it means the license plate number corresponding to the new cluster may have left the shooting range of the camera, or means the new cluster (the first update data) is likely to be generated due to license plate recognition error. Therefore, the computing device may perform step S063 to delete the new cluster.

Or, after the computing device generates the new representative, the computing device may perform step S062 to determine whether a number of pieces of data of the new cluster is smaller than a default number, and a time of the number of pieces of data being smaller than the default number reaches a default period, wherein the computing device may start timing the default period after generating the new representative or after receiving the first update data. In short, in step S062, the computing device determines whether a number of pieces of data of the new cluster does not increase within the default period, or that a number of pieces of data of the new cluster only increases a small amount within the default period.

Take license plate recognition as an example, when the computing device determines the number of pieces of data of the new cluster increases and reaches the default number, it means the license plate number corresponding to the new cluster is still within the shooting range of the camera and that the data of the new cluster is correctly recognized and is valid data. Therefore, the computing device may continue to perform step S01 to continuously receive update data. On the other hand, when the computing device determines the number of pieces of data of the new cluster does not reach the default number within the default period, it means the license plate number corresponding to the new cluster may have already left the shooting range of the camera, or means the new cluster (the first update data) is likely to be generated due to license plate recognition error. Therefore, the computing device may perform step S063 to delete the new cluster.

In addition, the updated cluster generated in step S07 of FIG. 1 may also be applied with step S06 in FIG. 4. That is, after generating the updated cluster, the computing device may determine whether the updated cluster is updated by another piece of update data within the default period, and/or determine whether the number of pieces of data of the updated cluster reaches the default number within the default period. When the computing device determines the updated cluster is not updated by another piece of update data within the default period, and/or determines the number of pieces of data of the updated cluster does not reach the default number within the default period, the computing device may delete the updated cluster. The default period in step S061 may be the same as the default period in step S062, the default period in step S061 may also be different from the default period in step S062.

In the method of updating data cluster of the present disclosure, one cluster may also contain repeated cluster data, and the repeated cluster data may be assigned with higher weight value for the repeated cluster data to have a higher chance of being used as the representative of the cluster. When the computing device receives the data deletion command regarding the repeated cluster data, the computing device may delete all pieces of repeated cluster data, the computing device may also lower the weight values of all pieces of repeated cluster data, for example, lower the weight values by 1 order.

In addition to license plate recognition, the method of updating data cluster of the present disclosure may also be applied to determine a location of a mobile base station as well as track an object in a video based on other data.

First, for the application of determining a location of a mobile base station, a plurality of pieces of existing data may be a plurality of coordinates of a plurality of mobile devices; the existing representative may be a location of a mobile base station suitable for the plurality of the mobile devices to access, wherein the existing representative may be a center location (average coordinate of the mobile devices) of the pieces of existing data. In this application, the update data is a coordinate of a newly added mobile device, and the first distance is an actual distance between the coordinate of the newly added mobile device and the coordinate of the mobile base station to determine whether the mobile base station that is the existing representative is also suable for the newly added mobile device to access. Through the method of updating data cluster of the present disclosure, one or more clusters may be determined, and the cluster representative may be used as the preferable location of the mobile base station. Accordingly, the cluster and cluster representative (preferable location of the mobile base station) may be determined efficiently, and the least number of base stations may be used to cover the largest communication range.

Second, for the application of tracking an object in a video, except for the license plate recognition mentioned above, the existing data and the update data may further include vehicle color, vehicle type, vehicle direction etc. In this application, if the vehicle color, vehicle type, and vehicle direction of the existing data and the vehicle color, vehicle type, and vehicle direction of the update data are respectively the same, the distances for the vehicle color, vehicle type, and vehicle direction are respectively 0 (if the existing data is not the same as the update data, the distance is 1). The first distance may be the sum or an average of the sum of these three distances. That is, if the vehicle color, vehicle type, and vehicle direction of the existing data and the vehicle color, vehicle type, and vehicle direction of the update data are completely the same, the first distance is 0; and if the vehicle color, vehicle type, and vehicle direction of the existing data and the vehicle color, vehicle type, and vehicle direction of the update data are completely different, the first distance is 3 (if the first distance is an average of the sum, then the first distance is 1). When the update data and the existing representative of the existing cluster are close to each other, the update data and the existing representative are likely to be indicating the same vehicle. Therefore, through the method of updating data cluster of the present disclosure, the computing device may summarize all the characteristics of the same vehicle to track each vehicle more accurately.

In view of the above description, according to one or more embodiments of the method of updating data cluster of the present disclosure, the update data may be used to directly compare with the cluster representative and only update the related cluster. Therefore, the amount of computation and time of the computing device spends on performing data comparison (searching for cluster) may be reduced. In addition, since the method of updating data cluster of the present disclosure may generate a suitable number of clusters (a suitable value k), the problem of generating inaccurate clusters due to choosing an inappropriate value k may be avoided. Therefore, even though the update data may be multi-dimensional data (high value d), an amount of computation for the computing device may not increase significantly. That is, the method of updating data cluster of the present disclosure may improve the performance of cluster classification without substantially increasing the computational complexity.

In summary, according to one or more embodiments of the method of updating data cluster of the present disclosure, the computing device may perform data clustering using a less amount of time as well as less amount of computation. Further, according to one or more embodiments of the method of updating data cluster of the present disclosure, a proper number of clusters may be automatically generated, and the user does not need to manually choose the value k.

What is claimed is:

1. A method of updating data cluster, adapted to a computing device, comprising:
receiving update data, and calculating a first distance between the update data and an existing representative of an existing cluster;
determining whether the first distance is smaller than a threshold distance;
updating the existing cluster with the update data to generate an updated cluster when the first distance is smaller than the threshold distance; and
performing a representative updating procedure on the updated cluster to generate an updated representative.

2. The method of updating data cluster according to claim 1, wherein the updated cluster comprises a plurality of pieces of cluster data, and the representative updating procedure comprises:
calculating a similarity between each one of the pieces of cluster data and the rest of the pieces of cluster data; and
using the piece of cluster data with the highest similarity as the updated representative.

3. The method of updating data cluster according to claim 1, wherein updating the existing cluster with the update data to generate the updated cluster comprises:
adding the update data into the existing cluster.

4. The method of updating data cluster according to claim 1, wherein receiving the update data comprises: receiving a data deletion command associated with the update data, and updating the existing cluster with the update data to generate the updated cluster:
deleting the update data that is existing data from the existing cluster to generate the updated representative.

5. The method of updating data cluster according to claim 1, wherein receiving the update data comprises: receiving a data replacing command associated with the update data and existing data, and updating the existing cluster with the update data to generate the updated cluster comprises:
deleting the existing data according to the data replacing command from the existing cluster; and
adding the update data into the existing cluster to generate the updated representative.

6. The method of updating data cluster according to claim 1, wherein the update data is a first cluster, the existing cluster is a second cluster, the existing representative is a second representative, and determining whether the first distance is smaller than the threshold distance, and updating the existing cluster with the update data to generate the updated cluster comprises:
determining whether the first distance between a first representative of the first cluster and the second representative is smaller than the threshold distance; and
merging the first cluster and the second cluster to generate the updated cluster when the first distance between the first representative and the second representative is smaller than the threshold distance.

7. The method of updating data cluster according to claim 1, wherein when the first distance is not smaller than the threshold distance, the method further comprises:
generating a new cluster based on the update data; and
using the update data as a new representative of the new cluster.

8. The method of updating data cluster according to claim 7, wherein the update data is first update data, and after generating the new representative, the method further comprises:
determining whether the new cluster is updated by second update data within a default period, wherein the default period starts after the first update data is received; and
deleting the new cluster when the new cluster is not updated by the second update data within the default period.

9. The method of updating data cluster according to claim 7, wherein after generating the new representative, the method further comprises:
determining whether a number of pieces of data of the new cluster is smaller than a default number, and a time of the number of pieces of data being smaller than the default number reaches a default period, wherein the default period starts after generating the new representative; and
deleting the new cluster when the time of the number of pieces of data being smaller than the default number reaches the default period.

10. The method of updating data cluster according to claim 1, wherein the existing cluster comprises a plurality of pieces of existing data, and a dimension of each one of the pieces of existing data and the update data is larger than 1 and is an integer.
